(19) United States
(12) Patent Application Publication
(10) Pub. No.: US 2021/0319510 A1
(43) Pub. Date: Oct. 14, 2021

(54) BLOCKCHAIN-BASED SYSTEM FOR PROVIDING MERGERS AND ACQUISITIONS SERVICE, AND OPERATION METHOD THEREFOR

(71) Applicant: GBC KOREA CO., LTD., Seoul (KR)

(72) Inventor: Jong Sung LEE, Seoul (KR)

(73) Assignee: GBC KOREA CO., LTD., Seoul (KR)

(21) Appl. No.: 17/355,786

(22) Filed: Jun. 23, 2021

Related U.S. Application Data
(63) Continuation of application No. PCT/KR2019/003975, filed on Apr. 4, 2019.

(30) Foreign Application Priority Data
Dec. 24, 2018 (KR) 10-2018-0168260

(51) Int. Cl. G06Q 40/04; G06Q 20/06; G06Q 40/06

(52) U.S. Cl. CPC G06Q 40/04; G06Q 40/06; G06Q 20/065

(57) ABSTRACT

A blockchain-based system for providing an mergers and acquisitions (M&A) service includes a main server for storing special purpose company (SPC) information about an SPC involved in an M&A negotiation for a company to be acquired, an M&A platform including a blockchain which stores a project created using the SPC information, and a user terminal for querying the SPC information corresponding to the project and participating in the M&A negotiation.

### CROSS-REFERENCE TO RELATED APPLICATIONS

The present application is a continuation application of International Application No. PCT/KR2019/003975, filed Apr. 4, 2019, which claims the benefit of and priority to Korean Application No. 10-2018-0168260, filed Dec. 24, 2018. The above-referenced applications are hereby incorporated herein by reference in their entirety.

### FIELD

Embodiments disclosed in the present disclosure relate to a blockchain-based system for providing mergers and acquisitions (M&A) service to implement a conventional mergers and acquisitions process based on a blockchain and an operation therefor.

### BACKGROUND

Mergers and acquisitions (M&A) have recently been a method for the sustainable growth of companies, and M&A have been a financial method that integrates companies by various transactions, such as public purchase, asset purchase, and management buyout. Such an M&A process is generally performed by a special type of financial institution called an investment bank, and the corresponding bank has expert knowledge capable of performing transactions. Because a process associated with various M&A transactions is very complicated, there is a need for a team composed of experts capable of successfully completing the transactions.

The M&A process may roughly include many stages, such as marketing, preliminary due diligence, preferred negotiator selection/due diligence on confirmation, close due diligence, price/trade condition adjustment, and the conclusion of a stock transfer contract. However, although the M&A process proceeds according to an exhaustive contract, it is difficult to include all contents in a contract.

Particularly, because one may evaluate values of tangible and intangible assets of companies fairly and accurately, M&A negotiations frequently fall apart in the stage where the terms of a deal are discussed.

Furthermore, an existing M&A process contains a problem of the leak of personal information. In principle, when providing a prospective buyer with internal member and customer information of a target company, prior consent from the parties of personal information should be obtained. However, it is a reality that it is customary to provide the prospective buyer with the corresponding information without prior consent for the purpose of due diligence for a merger.

### SUMMARY

According to an aspect of the present disclosure, a blockchain-based system for providing a mergers & acquisitions (M&A) service may include a main server that stores special purpose company (SPC) information about an SPC proceeding with an M&A negotiation of a target company, an M&A platform that includes a blockchain storing a project generated using the SPC information, and a user terminal that queries for the SPC information corresponding to the project and participate in the M&A negotiation.

According to an embodiment, the user terminal may purchase a share of the target company using a first cryptocurrency and may be paid a second cryptocurrency corresponding to the first cryptocurrency.

According to an embodiment, the user terminal may sell the share of the target company using the paid second cryptocurrency and may be paid the first cryptocurrency corresponding to the paid second cryptocurrency.

According to an embodiment, the project may include project identification information and share information about the target company.

According to an embodiment, the main sever and the M&A platform may correspond to off-chain and on-chain, respectively. The main sever and the M&A platform may communicate with each other through an oracle that converts and delivers information of the off-chain in the form of a smart contract to the on-chain or analyzes and delivers a smart contract of the on-chain to the off-chain.

According to an embodiment, the M&A platform may include a first chain layer grouping all nodes into a plurality of shards and a second chain layer grouping nodes that belong to any one of the plurality of shards into a plurality sub-chains.

According to an embodiment, the number of the plurality of shards, nodes making up each shard, and a leader node may be shuffled periodically and randomly.

According to an embodiment, a transaction generated by a node that belongs to any one of the plurality of sub-chains may be verified according to a consensus algorithm in the sub-chain to be included in a plasma block. A hash value of a header of the plasma block may be included in the transaction generated by the node that belongs to any one of the plurality of shards and may be verified according to a consensus algorithm in the shard to be included in a middle block. The middle block may be shared between the plurality of shards and may be verified according to a consensus algorithm between the plurality of shards to be included in a last block.

According to an embodiment, the consensus algorithm may be a proof of stake (PoS) scheme.

According to an embodiment, the user terminal may generate a transaction for reading the SPC information corresponding to the project depending on a query request of a user. The main server may transmit SPC information corresponding to an SPC information reading application to the user terminal, when the SPC information reading application generated according to the transaction is an SPC information reading application of an authorized member.

According to an embodiment, the blockchain-based system may further include a first exchange server that performs an exchange transaction for a first cryptocurrency and a second exchange server that manages a second cryptocurrency corresponding to the project.

According to an embodiment, the user terminal may transmit an exchange request for purchasing the first cryptocurrency to the first exchange server by means of an M&A application. The first exchange server may generate and deliver a transaction to the M&A platform, where the transaction includes a smart contract for transferring an ownership of the first cryptocurrency corresponding to an asset provided by an investor to the user terminal depending on the exchange request of the user terminal. The first exchange server may notify the user terminal that the exchange transaction is completed, when it is determined that the transaction is registered with the blockchain of the M&A platform.

According to an embodiment, the user terminal may generate a transaction for purchasing a share of the target company using the held first cryptocurrency. The transaction may be verified by a first chain layer and a second chain layer of the M&A platform and may be registered with the blockchain. The user terminal may be paid the second cryptocurrency corresponding to the first cryptocurrency when it is determined that the transaction is registered with the blockchain.

According to an embodiment, the transaction may include a smart contract of contents that the ownership of the first cryptocurrency is transferred from the user terminal to a holder of a share of the target company and the contents that an ownership of the second cryptocurrency corresponding to the first cryptocurrency is transferred from the holder of the share of the target company to the user terminal.

According to an embodiment, the user terminal may transmit an exchange request for selling the held second cryptocurrency to the second exchange server. The second exchange server may generate a transaction for selling a share of the target company using the second cryptocurrency the user terminal holds depending on the exchange request of the user terminal. The transaction may be verified by a first chain layer and a second chain layer of the M&A platform and may be registered with the blockchain. The second exchange server may notify the user terminal that the exchange transaction for selling the share is completed, when it is determined that the transaction is registered with the blockchain. The user terminal may be paid the first cryptocurrency corresponding to the second cryptocurrency.

According to an embodiment, the transaction may include a smart contract of contents that an ownership of the second cryptocurrency is transferred from the user terminal to a purchaser of a share of the target company and contents that an ownership of the first cryptocurrency corresponding to the second cryptocurrency is transferred from the purchaser of the share of the target company to the user terminal.

According to another aspect of the present disclosure, an operation method of a blockchain-based system for providing a mergers & acquisitions (M&A) service may include storing special purpose company (SPC) information about an SPC proceeding with an M&A negotiation of a target company, storing a project generated using the SPC information in a blockchain, and querying for the SPC information corresponding to the project and participating in the M&A negotiation.

### DRAWINGS

FIG. 1 is a drawing schematically illustrating a system for providing a mergers and acquisitions (M&A) service according to an embodiment of the present disclosure;

FIG. 2 is a block diagram illustrating in detail the main server shown in FIG. 1;

FIG. 3 is a drawing illustrating a blockchain structure of the M&A platform shown in FIG. 1;

FIG. 4 is a drawing illustrating a process where a last block is included in a root chain in the blockchain structure of FIG. 3;

FIG. 5 is a signal sequence diagram illustrating an example of a share purchase method in the system for providing the M&A service shown in FIG. 1;

FIG. 6 is a signal sequence diagram illustrating an example of a share sale method in the system for providing the M&A service shown in FIG. 1; and

FIG. 7 is a signal sequence diagram illustrating an example of a corporate liquidation method in the system for providing the M&A service shown in FIG. 1.

### DETAILED DESCRIPTION

An aspect of the present disclosure provides a blockchain-based system for providing an M&A service to supplement disadvantages of a conventional M&A process and an operation therefor.

The technical problems to be solved by the present disclosure are not limited to the aforementioned problems, and any other technical problems not mentioned herein will be clearly understood from the following description by those skilled in the art to which the present disclosure pertains.

According to embodiments disclosed in the present disclosure, an M&A service is provided using a blockchain to provide an opportunity of investment for an M&A field it is difficult for a general investor to access.

Furthermore, expert participation and costs essentially required to guarantee reliability in a process of transacting a share of the target company may be replaced using the blockchain technology having integrity and reliability.

In addition, the problem of personal information leaked indiscriminately in an existing M&A negotiation process may be solved by encrypting and providing personal information to an authorized user through the blockchain-based platform.

In addition, various effects ascertained directly or indirectly through the present disclosure may be provided.

Hereinafter, various embodiments of the disclosure may be described with reference to accompanying drawings. However, it should be understood that this is not intended to limit the present disclosure to specific implementation forms and includes various modifications, equivalents, and/or alternatives of embodiments of the present disclosure.

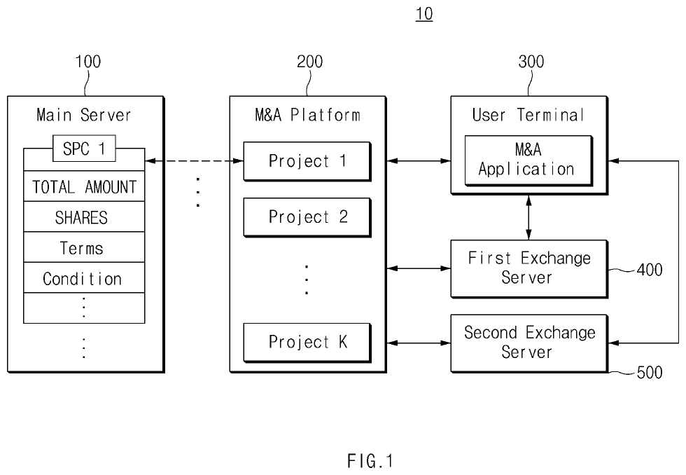

FIG. 1 is a drawing illustrating a system for providing a mergers and acquisitions (M&A) service according to an embodiment of the present disclosure.

Referring to FIG. 1, a system 10 for providing an M&A service is a blockchain-based system for providing an M&A service, which is capable of implementing an M&A service performed offline (in the field) based on on-chain by means of a block chain technology.

Blockchain may function as a public ledger, which may refer to a technology for preventing hacking capable of being generated upon the transaction of cryptocurrency or the like. An existing financial company keeps transaction records in a centralized server. However, the blockchain may distribute and record transaction records in computers of all users who participate in a transaction. Thus, the blockchain may be defined herein as a distributed ledger management technology for recording and storing information and values created by network participants in common. A blockchain distributed technology may be used to compare transaction records recorded in several computers for each cryptocurrency transaction to prevent data fabrication. In other words, because all participants share a ledger, integrity of transaction records may be guaranteed. Furthermore, the blockchain may provide time stamp records to prevent double expenditure and correction of previous transaction records and may save costs necessary for maintenance, security, financial transaction, and the like, because an authorized third party is not needed.

Bitcoin and Ethereum, which are blockchain-based cryptocurrencies, have been in the spotlight together with the blockchain. Bitcoin refers to a cryptocurrency capable of storing and maintaining transaction records by the blockchain technology, and Ethereum refers to a cryptocurrency capable of recording additional information, such as a contract as well as a transaction technology. Particularly, Ethereum is in the spotlight in that it is able to support a smart contract because it is able to record additional information.

The smart contract refers to a program code capable of executing and performing a contract or negotiation using the blockchain technology. Thus, the entire process may be automatized by the program code to supplement or replace a legal contract.

A cryptocurrency storage function of existing blockchain 1.0 is programmable in various forms. Ethereum may be a blockchain system capable of executing a smart contract, which may provide a global platform by means an Ethereum virtual machine (EVM). A developer may execute a smart contract through programming and may manage a digital asset, such as cryptocurrency.

The smart contract may be defined as an advanced automatic contract fulfillment method between machines in an unreliable computer network environment, and various platforms exist to develop various distributed applications, such as real estate contract, online votes, and healthcare on the blockchain.

A system 10 for providing an M&A service may be a system capable of supplementing a disadvantage of an M&A process, which is performed only offline in the past, by grafting and performing the M&A process onto the blockchain technology.

The system 10 for providing the M&A service according to an embodiment of the present disclosure may include a main server 100, an M&A platform 200, a user terminal 300, a first exchange server 400, and a second exchange server 500. Herein, each component of the system 10 for providing the M&A service shown in FIG. 1 is merely illustrative. Some components may be added or omitted, and at least one component may be divided into separate components and may be integrated into a separate component.

The main server 100 may be a server operated by a business entity that provides the M&A service, and the main server 100 may store, update, and maintain the overall control and various information of the M&A service. It is shown that the main server 100 is one server in FIG. 1, but the scope of the present disclosure is not limited thereto. If necessary (e.g., according to distribution of network loads or the like), the main server 100 may be divided into at least two or more servers to operate.

The main server 100 may upload at least one project to the M&A platform 200 and may interwork with the M&A platform 200 to process a response according to a request received from the M&A platform 200. Particularly, the main server 100 may store special purpose company (SPC) information about at least one SPC. The SPC may refer to a special purpose company for proceeding with an M&A negotiation for a target company, which is a target for the M&A service, and the SPC information may be determined when the SPC is established. The SPC information may include a total amount, shares, terms (e.g., 7 years), a condition (e.g., entrustment of management rights), the number of accounts, a rate of interest, expected return, information (e.g., member information, customer information, or the like) about other target companies, or the like.

The main server 100 may store SPC information about each of first SPC (SPC 1) to k (where k is 2 or more integers) SPCs (SPC k; not shown). Furthermore, the main server 100 may generate and upload projects (hereinafter “Project 1˜Project k”) for each of SPC 1˜SPC k using SPC information of each of SPC 1˜SPC k to the M&A platform 200. Each of the Project 1˜Project k may at least include project identification information and share information about a corresponding target company, which may include additional information.

The M&A platform 200 may include a database configured as a blockchain and may store the Project 1˜Project k for each of SPC 1˜SPC k, which are uploaded by the main server 100, in the database. Herein, the database may refer to a transaction maintenance DB in the blockchain, and, as the Project 1˜Project k are stored in the chained block, integrity may be ensured.

Because the M&A platform 200 has a structure configured as the blockchain, and the main server 100 is not associated with the blockchain, the M&A platform 200 may be referred to as on-chain, and the main server 100 may be referred to as off-chain. The main server 100 and the M&A platform 200 may be connected through an oracle, which is a link between the off-chain and the on-chain.

The oracle may perform a function of converting and delivering information of the off-chain in the form of a smart contract to the on-chain or analyzing and delivering a smart contract of the on-chain to the off-chain. Herein, the smart contract may be an instruction executable in the blockchain when a predefined condition is met, which may be included in a transaction.

The main server 100 may convert and deliver the projects Project 1˜Project k for each of SPC 1˜SPC k in the form of a smart contract to the M&A platform 200, such that the Project 1˜Project k for each of SPC 1˜SPC k may be uploaded to the M&A platform 200 through the oracle.

As the M&A platform 200 is configured as the blockchain, because it is unable for the M&A platform 200 to directly access data outside a network (e.g., the main server 100), the M&A platform 200 may fetch external data by a smart contract. For example, any one node in the M&A platform 200 may generate a transaction including a smart contract for reading information about a specific project, and the oracle verifying it may analyze and deliver the corresponding smart contract to the main server 100.

Furthermore, the M&A platform 200 may store transaction records of each of a first cryptocurrency (UCX) and a second cryptocurrency (UCC). Herein, the first cryptocurrency (UCX) may be a token issued in the outside by a business entity which provides the M&A service, which may be influenced by a situation of an exchange, and the second cryptocurrency (UCC) may be a special purpose token provided rather than stocks of a target company for project investment, which may be influenced by a stock market. The second cryptocurrency (UCC) may be generated, trade, and managed independently for each of the Project 1˜Project k, which may be represented as UCC 1˜UCC k. However, hereinafter, the second cryptocurrency UCC may be represented as UCC for convenience of description. Transaction records of each of the first cryptocurrency (UCX) and the second cryptocurrency UCC may be updated by a transaction generated by each node 300, 400, or 500 described below.

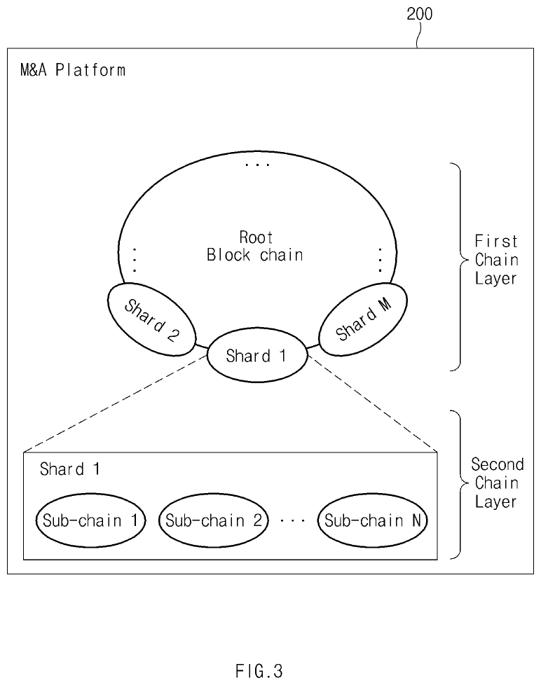

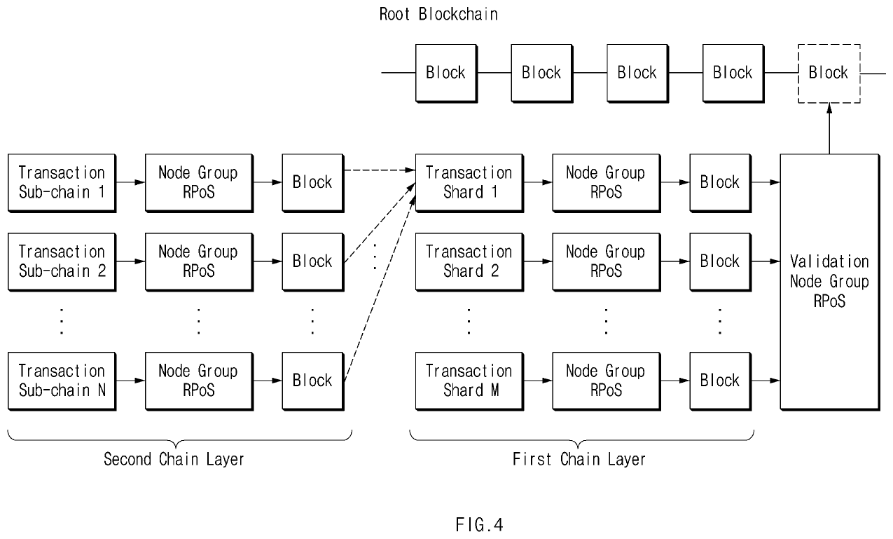

A detailed configuration and operation of the M&A platform 200 will be described with reference to FIGS. 3 and 4.

The user terminal 300 may be a terminal of an investor, which may be a device in which an M&A application distributed by the business entity which provides the M&A service may be installed and run. Herein, the user terminal 300 may be a smart phone, a tablet, a notebook, a personal computer (PC), or the like, but the scope of the present disclosure is not limited thereto. The M&A application may be a program for providing a user with an interface capable of participating in an M&A negotiation that is currently in progress. In detail, the M&A application may provide the user with an interface capable of reading information about an SPC which currently proceeds with an M&A negotiation and purchasing or selling a share of a target company (i.e., participating in the M&A negotiation) and an interface capable of accessing each exchange server 400 or 500 to perform a cryptocurrency transaction.

The user terminal 300 in which the M&A application is installed and run may participate as one node making up the blockchain of the M&A platform 200. In other words, the user terminal 300 may generate a transaction for reading SPC information corresponding to a specific project and may generate a transaction for purchasing or selling a share of a target company corresponding to the specific project. Furthermore, the user terminal 300 may verify a transaction generated by another user terminal.

The user terminal 300 may purchase the share of the target company corresponding to the specific project using the first cryptocurrency (UCX). In detail, the user terminal 300 may access the first exchange server 400 to exchange an asset (e.g., cash) of an investor for the first cryptocurrency (UCX). The user terminal 300 may generate a transaction for purchasing a share of a target company using the held first cryptocurrency (UCX). Such a transaction may include a smart contract of the contents that the ownership of the first cryptocurrency (UCX) is transferred from the user terminal 300 to a holder of the share of the target company and the contents that the ownership of the second cryptocurrency (UCC) corresponding to the first cryptocurrency (UCX) is transferred from the holder of the share of the target company to the user terminal 300. In other words, the user terminal 300 may purchase the share of the target company corresponding to the specific project using the first cryptocurrency (UCX). When the corresponding transaction is registered with the blockchain, the user terminal 300 may be paid the second cryptocurrency (UCC) corresponding to the first cryptocurrency (UCX) as a benefit in return. Thus, the user terminal 300 having the second cryptocurrency (UCC) may hold the share of the corresponding target company, and the second cryptocurrency (UCC) may function as a stock influenced by a stock market.

The user terminal 300 may hold the share of the target company corresponding to the specific project in the form of the second cryptocurrency (UCC) and may sell the share of the target company depending on a request of an investor. In detail, the user terminal 300 may access the second exchange server 500 to exchange the second cryptocurrency (UCC) for the first cryptocurrency (UCX). According to another embodiment, the user terminal 300 may access the second exchange server 500 to exchange the second cryptocurrency (UCC) for another type of cryptocurrency (e.g., Bitcoin). Herein, a description will be given below of a detailed process where the second exchange server 500 exchanges the second cryptocurrency (UCC) for the first cryptocurrency (UCX) depending on the request of the user terminal 300.

Although it is shown that the user terminal 300 is one in FIG. 1, but a plurality of user terminals may participate in a node making up the blockchain of the M&A platform 200.

The first exchange server 400 may function as an exchange which deals in various cryptocurrencies which trade in the market as well as the first cryptocurrency (UCX). Particularly, the first exchange server 400 may generate and deliver a transaction, including a smart contract for transferring the ownership of the first cryptocurrency (UCX) corresponding to an asset provided by an investor to the user terminal 300 depending on an exchange request of the user terminal 300 to the M&A platform 200. Thereafter, when it is determined that the corresponding transaction is registered with the blockchain, the first exchange server 400 may notify the user terminal 300 that the exchange transaction is completed.

The second exchange server 500 may manage the second cryptocurrencies (UCC 1˜UCC k) corresponding to each of the projects Project 1˜Projeck k and may pay the first cryptocurrency (UCX) corresponding to the second cryptocurrencies (UCC 1˜UCC k) depending on an exchange request of the user terminal 300.

In detail, the second exchange server 500 may generate a transaction for selling the share of the target company using the second cryptocurrencies (UCC 1˜UCC k) the user terminal 300 holds depending on an exchange request of the user terminal 300. Such a transaction may include a smart contract of the contents that the ownership of the second cryptocurrencies (UCC 1˜UCC k) is transferred from the user terminal 300 to a purchaser (e.g., the corresponding SPC) of the share of the target company, and the contents that the ownership of the first cryptocurrency (UCX) corresponding to the second cryptocurrencies (UCC 1˜UCC k) is transferred from the purchaser of the share of the target company to the user terminal 300. In other words, the user terminal 300 may hold and sell the share of the target company corresponding to the specific project using the second cryptocurrencies (UCC 1˜UCC k). When the corresponding transaction is registered with the blockchain, the user terminal 300 may be paid the first cryptocurrency (UCX) corresponding to the second cryptocurrencies (UCC 1˜UCC k) as a benefit in return.

It is shown that the user terminal 300, the first exchange server 400, and the second exchange server 500 are components independent of the M&A platform 200 in FIG. 1, but the user terminal 300, the first exchange server 400, and the second exchange server 500 may operate as one node of the blockchain of the M&A platform 200.

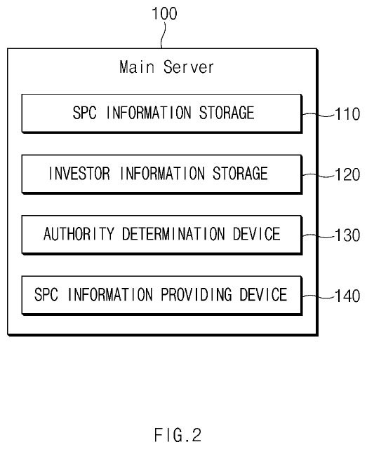

FIG. 2 is a block diagram illustrating in detail the main server shown in FIG. 1.

Referring to FIG. 2, a main server 100 may include an SPC information storage 110, an investor information storage 120, an authority determination device 130, and an SPC information providing device 140.

The SPC information storage 110 may store and manage SPC information of each of SPC 1˜SPC k. The SPC information storage 110 may deliver the corresponding SPC information to the SPC information providing device 140 depending on a request of the SPC information providing device 140.

The investor information storage 120 may store information about an investor who installs an M&A application in a user terminal 300 and logs in to the M&A application. Herein, the information about the investor may include identification information (e.g., a name or an ID) of the investor, visit record information (e.g., a visit page log record), a current situation of shareholding, a current situation of cryptocurrency holding, a member level, or the like.

The authority determination device 130 may determine whether to approve an SPC information reading request of the user terminal 300. Herein, the SPC information reading request may refer to a request to read SPC information corresponding to a specific project where the user terminal 300 generates a transaction including a smart contract for reading information about the specific project and where the smart contract is analyzed and transferred by an oracle. The authority determination device 130 may determine whether an SPC information reading application is an SPC information reading request of an authorized member by means of the information of the investor of the investor information storage 120.

When the SPC information reading application is the SPC information reading request of the authorized member, the authority determination device 130 may control the SPC information providing device 140 to deliver SPC information corresponding to the SPC information reading application to the user terminal 300.

The SPC information providing device 140 may fetch and deliver the SPC information from the SPC information storage 110 to the user terminal 300 under control of the authority determination device 130. At this time, the SPC information may be converted in the form of a smart contract by the oracle to be delivered to the M&A platform 200. A node except for the user terminal 300 may be encrypted not to read the corresponding SPC Information. The user terminal 300 may decrypt and read the encrypted SPC information using a private key stored in the M&A application.

FIG. 3 is a drawing illustrating a blockchain structure of the M&A platform shown in FIG. 1.

Referring to FIG. 3, a blockchain structure of an M&A platform 200 may have a multiplexed form. In other words, a blockchain of the M&A platform 200 may be composed of a first chain layer and a second chain layer.

The first chain layer may include all nodes connected to a blockchain network and may include a root block chain composed of blocks, the verification of which is finally completed.

The first chain layer may include all nodes globally distributed, which are connected to the blockchain network such that consensus algorithms for verifying a transaction may be performed in parallel using a sharding protocol to increase the number of transactions capable of being processed per second.

In detail, the first chain layer may group all nodes into M shards shard 1˜shard M. A leader node may be randomly selected from each of the grouped M (M is 2 or more integers) shards shard 1˜shard M. The leader node may collect and broadcast node IDs (or node addresses) of all nodes in the shard to which the leader node belongs to a leader node of another shard. Herein, M may be randomly determined, and the number of nodes included in each shard may be the same or differ from each other for each shard.

Meanwhile, a transaction generated by a node that belongs to a specific shard may be verified according to a consensus algorithm in the shard to be included in a middle block. The middle block, the verification of which is completed, may be shared with other shards and may be verified according to a consensus algorithm between the shards to be included in a last block. Herein, the last block refers to a block included in the root block chain. The transaction being registered with the blockchain, which is described above in FIG. 1, may mean that a block including the corresponding transaction is included in the root block chain.

The consensus algorithm in the shard may use a proof of stake (PoS) scheme that increases a probability that a node having the highest age of a held cryptocurrency (UCX or UCC) among nodes which belong to the shard will generate a new block. Furthermore, the consensus algorithm between the shards may use a PoS scheme that increases a probability that a node having the highest age of a held cryptocurrency (UCX or UCC) among leader nodes of shard 1˜shard M will generate a new block.

Meanwhile, the generation of shard 1˜shard M and the random selection of the leader node may not be performed just once and fixed, but it may be performed periodically. That is, the number of shards, the nodes making up each shard, and a leader node may be randomly shuffled per period. This may contribute greatly to reducing a risk of hacking the blockchain network. The period of the shuffling may be suitably selected not to increase a network load.

The first chain layer may be a sharding protocol applying a PoS consensus algorithm, which may be defined as an RPoS sharding protocol in terms of being shuffled periodically and randomly.

By the second chain layer, all nodes may be divided into a plurality of shards (shard 1˜shard M) to perform a consensus algorithm and the number of transactions capable of being generated per second may be increased.

The second chain layer may indicate a blockchain structure in each shard of the first chain layer, which may have a plasma blockchain structure. Herein, a first shard (e.g., shard 1) from among the plurality of shards (shard 1˜shard M) is exemplified, but the same structure and operation is applicable to other shards shard 2˜shard M.

The second chain layer may be composed of first to Nth (N is 2 or more integers) sub-chains (hereinafter referred to as sub-chain 1˜sub-chain N) included in the shard 1. Nodes which belong to the shard 1 may participate in any one of sub-chain 1˜sub-chain N, but it may not participate in other embodiments. In the disclosure, it is assumed that each of the nodes that belong to the shard 1 participate in any one of the sub-chain 1˜sub-chain N and operates as a client.

Each of sub-chain 1˜sub-chain N may be a plasma chain, which may be a child chain for a root chain that is a parent chain.

Each of sub-chain 1˜sub-chain N may operate according to an internal consensus algorithm, and the consensus algorithm may be a PoS according to an embodiment. That is, when any one node generates a transaction, a block generator according to PoS of a sub-chain to which the node belongs may verify the transaction to generate a plasma block. A hash value of a header of the plasma block may be included in the transaction in the first chain layer to be finally included in the root chain. Herein, as the hash value of the header of the plasma block including the transaction is stored in the root chain rather than the transaction itself generated by the node, an effect where transactions included in the plasma block that is substantially sub-block are stored in the root chain may be obtained and thus a network load may be reduced.

FIG. 4 is a drawing illustrating a process where a last block is included in a root chain in the blockchain structure of FIG. 3.

Referring to FIG. 4, when a node which belongs to each of sub-chain 1˜sub-chain N in a second chain layer generates transaction sub-chain 1˜transaction sub-chain N, each of sub-chain 1˜sub-chain N may verify each transaction depending on an internal consensus algorithm (e.g., PoS), and a block generator may collect the transactions, the verification of which is completed, to generate a plasma block.

A hash value of a header of the plasma block generated by each of sub-chain 1˜sub-chain N may be included in the transaction shard 1 generated by a node which belongs to the shard 1 of a first chain layer. Only the transaction shard 1 is shown in FIG. 4, but the same manner is applicable to transaction shard 2˜transaction shard M.

Each of transaction shard 1˜transaction shard M may be verified according to a consensus algorithm (e.g., PoS) in the shard in each of shard 1˜shard M to be included in a middle block. The middle block, the verification of which is completed, may be shared with other shards and may be verified according to a consensus algorithm (e.g., PoS) between shards to be included in the last block.

As described in FIGS. 3 and 4, as the scheme by the RPoS sharding protocol of the first chain layer and the plasma blockchain scheme of the second chain layer are applied in a complex manner, the smart contract included in the transaction may be faster processed and the number of transactions capable of being processed per second may be considerably increased.

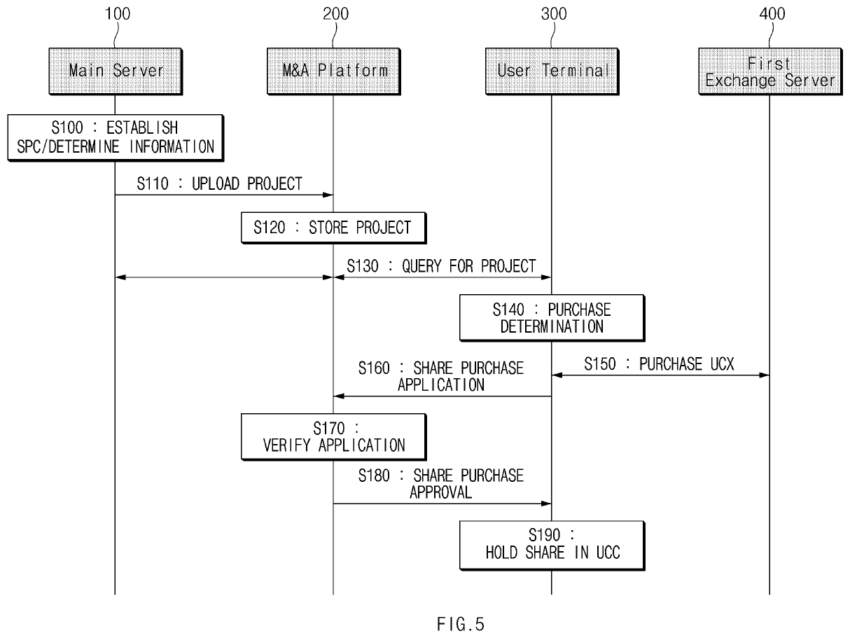

FIG. 5 is a signal sequence diagram illustrating an example of a share purchase method in the system for providing the M&A service shown in FIG. 1.

Referring to FIG. 5, an SPC which is a special purpose company for proceeding with an M&A negotiation for a target company may be established and the SPC information including a total amount, shares, terms (e.g., 7 years), a condition (e.g., entrustment of management rights), the number of accounts, a rate of interest, expected return, information (e.g., member information, customer information, or the like) about other target companies, or the like may be determined when the SPC is established (S100).

A main server 100 may collect information for an M&A negotiation of each of SPC 1˜SPC k to generate and upload Projects 1˜Project k to an M&A platform 200 (S110).

The M&A platform 200 may store Project 1˜Project k for each of SPC 1˜SPC k, which are uploaded by the main server 100, in a database (e.g., a root blockchain) configured as a blockchain (S120).

A user terminal 300 in which an M&A application is installed and run may participate as one node making up the blockchain of the M&A platform 200 and may generate a transaction for reading SPC information corresponding to a specific project depending to a query request of a user. Such a transaction may be analyzed by an oracle, and an SPC information reading application may be delivered to the main server 100. When the SPC information reading application is an SPC information reading application of an authorized member, the main server 100 may deliver SPC information corresponding to the SPC information reading application to the user terminal 300 through the oracle (S130).

The user may analyze the provided SPC information and may determine whether to purchase a share of a target company (S140).

When the user determines to purchase the share of the target company corresponding to the specific project, the user terminal 300 may transmit an exchange request for purchasing a first cryptocurrency (UCX) to a first exchange server 400 using the M&A application. The first exchange server 400 may generate and deliver a transaction, including a smart contract for transferring the ownership of the first cryptocurrency (UCX) corresponding to an asset provided by an investor to the user terminal 300 depending on the exchange request of the user terminal 300 to the M&A platform 200. Thereafter, when it is determined that the corresponding transaction is registered with the blockchain, the first exchange server 400 may notify the user terminal 300 that the exchange transaction is completed (S150).

The user terminal 300 may generate a transaction (i.e., a share purchase application) for purchasing the share of the target company using the held first cryptocurrency (UCX) (S160). Such a transaction may include a smart contract of the contents that the ownership of the first cryptocurrency (UCX) is transferred from the user terminal 300 to a holder of the share of the target company, and the contents that the ownership of the second cryptocurrency (UCC) corresponding to the first cryptocurrency (UCX) is transferred from the holder of the share of the target company to the user terminal 300.

The transaction corresponding to the share purchase application may be verified by a first chain layer and a second chain layer of the M&A platform 200 to be finally registered with the root blockchain.

When it is determined that the transaction corresponding to the share purchase application is registered with the root blockchain (S180), the user terminal 300 may be paid the second cryptocurrency (UCC) corresponding to the first cryptocurrency (UCX) to hold the share of the corresponding target company (S190).

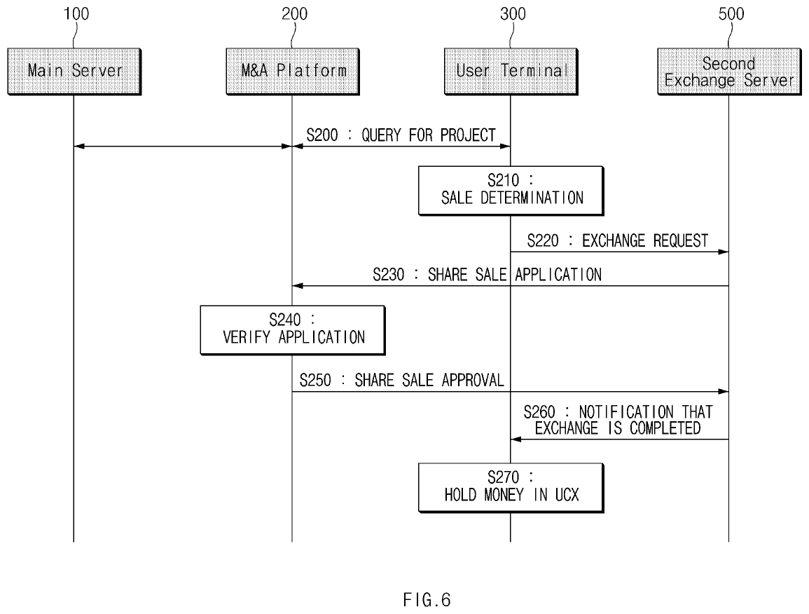

FIG. 6 is a signal sequence diagram illustrating an example of a share sale method in the system for providing the M&A service shown in FIG. 1.

Referring to FIG. 6, a user terminal 300 in which an M&A application is installed and run may generate a transaction for reading SPC information corresponding to a specific project depending on a query request of a user. Such a transaction may be analyzed by an oracle and an SPC information reading application may be delivered to a main server 100. When the SPC information reading application is an SPC information reading application of an authorized member, the main server 100 may deliver SPC information corresponding to the SPC information reading application to the user terminal 300 through the oracle (S200).

The user may analyze the provided SPC information and may determine whether to sell a share of a target company.

When the user determines to sell the share of the target company corresponding to the specific project, the user terminal 300 may transmit an exchange request for selling a second cryptocurrency (UCC) to a second exchange server 500 by means of the M&A application (S220).

The second exchange server 500 may generate a transaction (i.e., a share sale application) for selling the share of the target company using the second cryptocurrencies (UCC 1˜UCC k) the user terminal 300 holds depending on the exchange request of the user terminal 300 (S230). Such a transaction may include a smart contract of the contents that the ownership of the second cryptocurrencies (UCC 1˜UCC k) is transferred from the user terminal 300 to a purchaser (e.g., a corresponding SPC) of the share of the target company, and the contents that the ownership of the first cryptocurrency (UCX) corresponding to the second cryptocurrencies (UCC 1˜UCC k) is transferred from the purchaser of the share of the target company to the user terminal 300.

The transaction corresponding to the share sale application may be verified by a first chain layer and a second chain layer of the M&A platform 200 to be finally registered with a root blockchain.

When it is determined that the transaction corresponding to the share sale application is registered with the root blockchain (S250), the second exchange server 500 may notify the user terminal 300 that the exchange transaction for selling the share is completed (S260).

The user terminal 300 may be paid a first cryptocurrency (UCX) corresponding to the second cryptocurrency (UCC) to hold money in which the share of the corresponding target company is sold (S270). Of course, the user terminal 300 may exchange the held first cryptocurrency (UCX) for another type of cryptocurrency, cash, or the like later using the first exchange server 400.

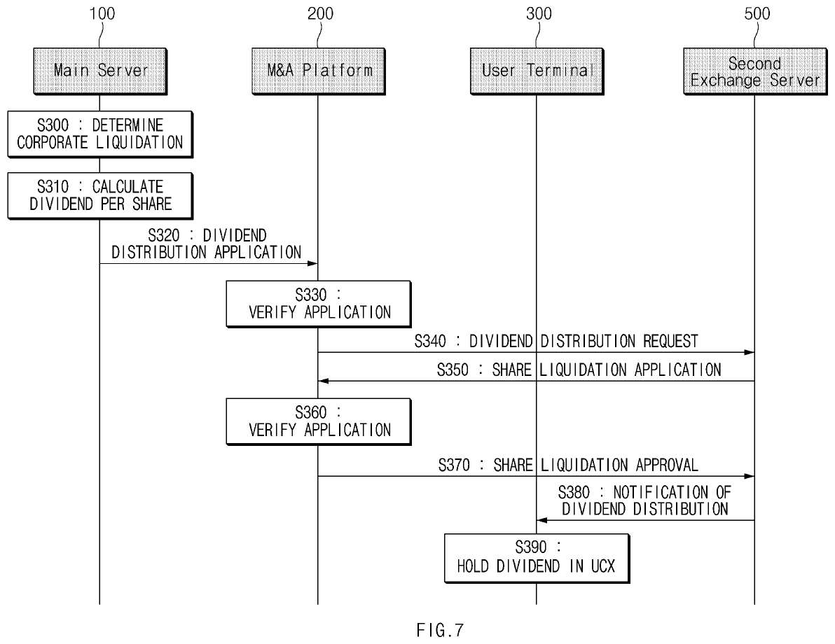

FIG. 7 is a signal sequence diagram illustrating an example of a corporate liquidation method in the system for providing the M&A service shown in FIG. 1.

Referring to FIG. 7, when a period of time (e.g., 7 years) fixed at the time of establishing an SPC expires, the corresponding SPC may enter a corporate liquidation procedure and may switch to a corporation in liquidation (S300).

When a liquidation procedure of a specific SPC is initiated, a main server 100 may divide a dividend obtained by subtracting a settlement amount (e.g., an initial input cost+corporate operating expenses) from the total amount of SPC information of the corresponding SPC by the number of all accounts to calculate a dividend per share (S310). Herein, the dividend per share may be converted into units of a first cryptocurrency (UCX).

The main server 100 may deliver a dividend distribution application for dividend distribution to a user terminal 300 to an M&A platform 200 (S320). The dividend distribution application may be converted in the form of a smart contract by an oracle to be delivered to the M&A platform 200. The smart contract may include identification information of an SPC, the liquidation procedure of which is initiated, a dividend per share, and information requesting a second exchange server 500 to execute dividend distribution.

The transaction including the smart contract corresponding to the dividend distribution application may be verified by a first chain layer and a second chain layer of the M&A platform 200 to be finally registered with a root blockchain (S330).

The second exchange server 500 may determine that the transaction including the smart contract corresponding to the dividend distribution application is registered with the root blockchain (S340).

The second exchange server 500 may calculate a first cryptocurrency (UCX) allocated to the user terminal 300 based on a second cryptocurrency (UCC) the user terminal 300 holds and the dividend per share depending on the dividend distribution application. For example, because the dividend per share refers to the first cryptocurrency (UCX) per account, the first cryptocurrency (UCX) allocated to the user terminal 300 may be calculated by a multiplication operation with the second cryptocurrency (UCC) the user terminal 300 holds.

The second exchange server 500 may generate a transaction (i.e., a share liquidation application) for liquidating a share of a target company (S350). Such a transaction may include a smart contract of the contents that the ownership of the second cryptocurrency (UCC) the user terminal 300 holds is transferred from the user terminal 300 to a corresponding corporation in liquidation, and the contents that the ownership of the first cryptocurrency (UCX) allocated to the user terminal 300 is transferred from the corresponding corporation in liquidation to the user terminal 300.

The transaction corresponding to the share liquidation application may be verified by the first chain layer and the second chain layer of the M&A platform 200 to be finally registered with a root blockchain (S360).

When it is determined that the transaction corresponding to the share liquidation application is registered with the root blockchain (S370), the second exchange server 500 may notify the user terminal 300 that the dividend distribution due to the liquidation of the SPC is completed (S380).

The user terminal 300 may be paid the first cryptocurrency (UCX) corresponding to the held share (i.e., the second cryptocurrency (UCC)) to hold a dividend due to the liquidation of the SPC (S390). Of course, the user terminal 300 may exchange the held first cryptocurrency (UCX) for another type of cryptocurrency, cash, or the like later by the first exchange server 400.

According to the blockchain-based system 10 for providing the M&A service according to an embodiment of the present disclosure, the M&A service may be provided using the blockchain to provide an opportunity of investment for the M&A field it is difficult for general investors to access.

Furthermore, expert participation and costs essentially required to guarantee reliability in a process of transacting the share of the target company may be replaced using the blockchain technology having integrity and reliability.

In addition, the problem of personal information leaked indiscriminately in an existing M&A negotiation process may be solved by encrypting and providing personal information to an authorized user through the blockchain-based platform.

Various embodiments of the present disclosure and terms used therein are not intended to limit the technical features described in the present disclosure to particular embodiments, and it should be construed as including various modifications, equivalents, or alternatives of a corresponding embodiment. With regard to description of drawings, similar denotations may be used for similar or related components. A singular form of a noun corresponding to an item may include one item or a plurality of the items unless context clearly indicates otherwise. As used herein, each of the expressions “A or B,” “at least one of A and B,” “at least one of A or B,” “A, B, or C,” “at least one of A, B, and C,” and “at least one of A, B, or C,” may include all possible combinations of the items listed together with a corresponding expression among the expressions. Terms as “1st” and “2nd,” or “first” and “second” may be used to distinguish a corresponding component from another, and do not limit the components in another aspect (e.g., importance or order). If an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., via a wire), wirelessly, or via a third element.

The term “module” used in the present disclosure may include a unit implemented in hardware, software, or firmware, and may be interchangeably used with terms, such as “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

Various embodiments of the present disclosure may be implemented as software (e.g., a program) including one or more instructions stored in a storage medium (e.g., an internal memory or an external memory) readable by a machine (e.g., an electronic device). For example, a processor (e.g., a processor) of a machine (e.g., an electronic device) may invoke at least one instruction among one or more stored instructions from the storage medium and may execute it. This may allow the machine to be operated to perform at least one function depending on the at least one invoked instruction. The one or more instructions may contain a code made by a compiler or a code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semi permanently stored in the storage medium and where data is temporarily stored in the storage medium.

According to an embodiment, a method according to various embodiments disclosed in the present disclosure may be included and provided in a computer program product. The computer program product may be traded as commodities between sellers and buyers. The computer program product may be distributed in the form of a machine-readable storage medium (e.g., a compact disc read only memory (CD-ROM)) or may be distributed (e.g., downloaded or uploaded) directly or online through an application store (e.g., PlayStore™) or between two user devices. When distributed online, at least part of the computer program product may be at least temporarily stored in a machine-readable storage medium, such as a memory of the manufacturer's server, a server of the application store, or a relay server, and may be temporarily generated.

According to various embodiments, each (e.g., a module or program) of the above-mentioned components may include a single entity or a plurality of entities, and some of the plurality of entities may be separately arranged in another component. According to various embodiments, one or more components of the above-mentioned components or operations may be omitted, or one or more other components or operations may be added. Alternatively or additionally, the plurality of components (e.g., modules or programs) may be integrated into one component. In such a case, the integrated component may one or more functions of each of the plurality of components to be the same or similar to being performed by a corresponding component of the plurality of components before the integration. According to various embodiments, operations performed by modules, programs, or other components may be carried out sequentially, in parallel, repeatedly, or heuristically, or at least one or more of the operations may be executed in a different order or omitted, or other operations may be added.

What is claimed is:

1. A blockchain-based system for providing an mergers and acquisitions (M&A) service, the blockchain-based system comprising:
a main server configured to store special purpose company (SPC) information about an SPC proceeding with an M&A negotiation of a target company;
an M&A platform configured to include a blockchain storing a project generated using the SPC information; and
a user terminal configured to query for the SPC information corresponding to the project and participate in the M&A negotiation.

2. The blockchain-based system of claim 1, wherein the user terminal purchases a share of the target company using a first cryptocurrency and is paid a second cryptocurrency corresponding to the first cryptocurrency.

3. The blockchain-based system of claim 2, wherein the user terminal sells the share of the target company using the paid second cryptocurrency and is paid the first cryptocurrency corresponding to the paid second cryptocurrency.

4. The blockchain-based system of claim 1, wherein the project includes project identification information and share information about the target company.

5. The blockchain-based system of claim 1, wherein:
the main sever and the M&A platform correspond to off-chain and on-chain, respectively, and
the main sever and the M&A platform communicate with each other through an oracle that converts and delivers information of the off-chain in the form of a smart contract to the on-chain or analyzes and delivers a smart contract of the on-chain to the off-chain.

6. The blockchain-based system of claim 1, wherein the M&A platform includes:
a first chain layer grouping all nodes into a plurality of shards, and
a second chain layer grouping nodes that belong to any one of the plurality of shards into a plurality sub-chains.

7. The blockchain-based system of claim 6, wherein the number of the plurality of shards, nodes making up each shard, and a leader node are shuffled periodically and randomly.

8. The blockchain-based system of claim 6, wherein:
a transaction generated by a node that belongs to any one of the plurality of sub-chains is verified according to a consensus algorithm in the sub-chain to be included in a plasma block,
a hash value of a header of the plasma block is included in the transaction generated by the node that belongs to any one of the plurality of shards and is verified according to a consensus algorithm in the shard to be included in a middle block, and
the middle block is shared between the plurality of shards and is verified according to a consensus algorithm between the plurality of shards to be included in a last block.

9. The blockchain-based system of claim 8, wherein the consensus algorithm is a proof of stake (PoS) scheme.

10. The blockchain-based system of claim 1, wherein the user terminal generates a transaction for reading the SPC information corresponding to the project depending on a query request of a user, and
wherein the main server transmits SPC information corresponding to an SPC information reading application to the user terminal when the SPC information reading application generated according to the transaction is an SPC information reading application of an authorized member.

11. The blockchain-based system of claim 1, further comprising:
a first exchange server configured to perform an exchange transaction for a first cryptocurrency; and
a second exchange server configured to manage a second cryptocurrency corresponding to the project.

12. The blockchain-based system of claim 11, wherein the user terminal transmits an exchange request for purchasing the first cryptocurrency to the first exchange server by means of an M&A application,
wherein the first exchange server generates and delivers a transaction to the M&A platform, wherein the transaction includes a smart contract for transferring an ownership of the first cryptocurrency corresponding to an asset provided by an investor to the user terminal depending on the exchange request of the user terminal; and
wherein the first exchange server notifies the user terminal that the exchange transaction is completed when it is determined that the transaction is registered with the blockchain of the M&A platform.

13. The blockchain-based system of claim 11, wherein the user terminal generates a transaction for purchasing a share of the target company using the held first cryptocurrency,
wherein the transaction is verified by a first chain layer and a second chain layer of the M&A platform and is registered with the blockchain, and
wherein the user terminal is paid the second cryptocurrency corresponding to the first cryptocurrency when it is determined that the transaction is registered with the blockchain.

14. The blockchain-based system of claim 13, wherein the transaction includes a smart contract of contents that the ownership of the first cryptocurrency is transferred from the user terminal to a holder of a share of the target company, and contents that an ownership of the second cryptocurrency corresponding to the first cryptocurrency is transferred from the holder of the share of the target company to the user terminal.

15. The blockchain-based system of claim 11, wherein the user terminal transmits an exchange request for selling the held second cryptocurrency to the second exchange server,
wherein the second exchange server generates a transaction for selling a share of the target company using the second cryptocurrency the user terminal holds depending on the exchange request of the user terminal,
wherein the transaction is verified by a first chain layer and a second chain layer of the M&A platform and is registered with the blockchain,
wherein the second exchange server notifies the user terminal that the exchange transaction for selling the share is completed when it is determined that the transaction is registered with the blockchain, and
wherein the user terminal is paid the first cryptocurrency corresponding to the second cryptocurrency.

16. The blockchain-based system of claim 15, wherein the transaction includes a smart contract of contents that an ownership of the second cryptocurrency is transferred from the user terminal to a purchaser of a share of the target company and contents that an ownership of the first cryptocurrency corresponding to the second cryptocurrency is transferred from the purchaser of the share of the target company to the user terminal.

17. An operation method of a blockchain-based system for providing an M&A service, the operation method comprising:
storing special purpose company (SPC) information about an SPC proceeding with an M&A negotiation of a target company;
storing a project generated using the SPC information in a blockchain; and
querying for the SPC information corresponding to the project and participating in the M&A negotiation.
